(19) United States
(12) Patent Application Publication
(10) Pub. No.: US 2015/0009012 A1
(43) Pub. Date: Jan. 8, 2015

(54) ELECTRONIC DEVICE ABLE TO BE IDENTIFIED UNAUTHORIZED DISASSEMBLY

(71) Applicant: Transcend Information, Inc., Taipei City (TW)

(72) Inventor: Kuan-De WU, Taipei City (TW)

(21) Appl. No.: 13/937,187

(22) Filed: Jul. 8, 2013

(51) Int. Cl. G06K 7/10

(52) U.S. Cl. CPC G06K 7/10009; G06K 7/10366
USPC 340/10.1

(57) ABSTRACT

An electronic device able to be identified unauthorized disassembly provided in the disclosure includes a case and a RFID tamper-evident label. The case is provided with two external shells separably combined with each other, and an inner space formed between the external shells for containing the RFID tamper-evident label therein. In one embodiment, the RFID tamper-evident label hidden in the inner space is connected to both of the external shells. Thus, once the external shells had been separated, because the RFID tamper-evident label is torn into two pieces, the RFID tamper-evident label cannot be read anymore, thus, a message that the case had been opened is notified.

### BACKGROUND

1. Field of Disclosure

The disclosure relates to a device. More particularly, the disclosure relates to an electronic device able to be identified unauthorized disassembly.

2. Description of Related Art

For some purposes, an open-able object, such as container or electronic device, is normally attached with a tamper-evident tape onto a seam defined by two separable outer surfaces of the open-able object. Once the open-able object is opened, the tamper-evident tape is broken into two pieces. Even thought the open-able object is closed again, because the broken tamper-evident tape is no longer intact on the outer surfaces of the open-able object, showing that the open-able object had ever been opened.

However, since the tamper-evident tape is attached on the outer surfaces of the open-able object, the paste mark of the tamper-evident tape remaining on the open-able object or the tamper-evident tape itself appearing outwards the open-able object will lower the aesthetic of the open-able object, so as affect the integrity of the open-able object and customer desire for purchasing.

Also, since the open-able object can be opened without breaking the temper-evident type for malicious purposes, people have to manually identify whether the temper-evident type is intact to determine if the open-able object had never been opened.

Further, the tamper-evident attached on the surface of the open-able object may be broken by accident. Thus, there is a need for accurately and reliably identify whether or not the open-able object had never been opened.

### SUMMARY

An aspect of the present application is to provide an electronic device able to be identified unauthorized disassembly. The electronic device comprises a case, an electronic module and a first RFID tamper-evident label. The case comprises a first external shell and a second external shell separably assembled with the first external shell to define an inner space therebetween. The electronic module is disposed in the inner space. The first RFID tamper-evident label is disposed in the inner space, connected to any two of the first external shell, the second external shell and the electronic module, and the first RFID tamper-evident label is configured to be broken apart along with a separation of the first external shell and the second external shell.

Another aspect of the present application is to provide an electronic device able to be identified unauthorized disassembly. The electronic device comprises a case and a first RFID tamper-evident label. The case comprises a first external shell, a second external shell and an inner space. The first external shell and the second external shell are separably assembled with each other, so that an inner space is defined therebetween. The first RFID tamper-evident label is arranged in the inner space wherein the first RFID tamper-evident label is configured to be broken along with a separation of the first external shell and the second external shell, and information stored therein is unreadable after the first RFID tamper-evident label is broken.

### BRIEF DESCRIPTION OF THE DRAWINGS

The present disclosure will be apparent to those skilled in the art by reading the following detailed description of a preferred embodiment thereof, with reference to the attached drawings, in which:

FIG. 1A is a schematic diagram illustrating a first external shell and a second external shell of an electronic device are assembled according to an embodiment of the present disclosure;

FIG. 1B is a schematic diagram illustrating the first external shell and the second external shell of FIG. 1A are disassembled;

FIG. 2 is a schematic diagram illustrating exemplary manipulations between the electronic device of FIG. 1A and a RFID reader/writer.

FIG. 3A is a schematic diagram illustrating a first external shell and a second external shell of an electronic device are assembled according to an embodiment of the present disclosure;

FIG. 3B is a schematic diagram illustrating the first external shell and the second external shell of FIG. 3A are disassembled;

FIG. 4 is a schematic diagram illustrating a first external shell and a second external shell of an electronic device are assembled according to an embodiment of the present disclosure;

FIG. 5A is a schematic diagram illustrating a first external shell and a second external shell of an electronic device are assembled according to an embodiment of the present disclosure;

FIG. 5B is a schematic diagram illustrating the first external shell and the second external shell of FIG. 5A are disassembled;

FIG. 6 is a schematic diagram illustrating a first external shell and a second external shell of an electronic device are assembled according to an embodiment of the present disclosure;

FIG. 7 is a schematic diagram illustrating a first external shell and a second external shell of an electronic device are assembled according to an embodiment of the present disclosure;

FIG. 8A is a schematic diagram illustrating a first external shell and a second external shell of an electronic device are assembled according to an embodiment of the present disclosure;

FIG. 8B is a schematic diagram illustrating the first external shell and the second external shell of FIG. 8A are disassembled;

FIG. 9A is a front view illustrating the first RFID tamper-evident label according to an embodiment of the present disclosure;

FIG. 9B is a front view illustrating the first RFID tamper-evident label according to an embodiment of the present disclosure;

FIG. 10A is a front view illustrating the first RFID tamper-evident label with a tear structure according to an embodiment of the present disclosure; and

FIG. 10B is a front view illustrating the first RFID tamper-evident label with another tear structure according to an embodiment of the present disclosure.

### DETAILED DESCRIPTION

The spirit of the disclosure will be described clearly through the drawings and the detailed description as follows. Any of those of ordinary skills in the art can make modifications and variations from the technology taught in the disclosure after understanding the embodiments of the disclosure, without departing from the sprite and scope of the disclosure.

The disclosure is to provide an openable electronic device having a radio frequency identification (hereinafter called RFID) tag fixed therein, rather than attaching tamper-evident tapes on the outer appearance surfaces of the electronic device. Therefore, people can electronically identify whether the electronic device had been disassembled under no authorization without visual checking, so as to enhance the aesthetic of the electronic device.

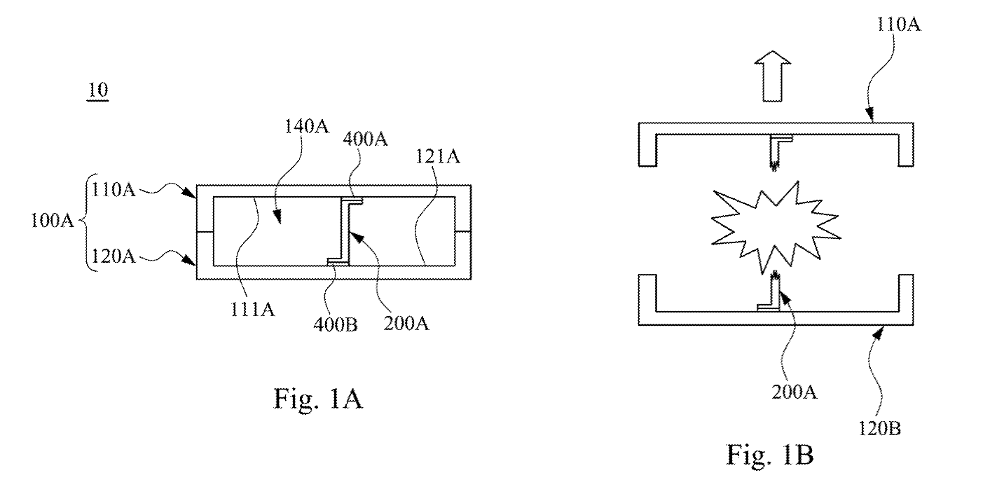

Reference is now made to FIG. 1A and FIG. 1B. FIG. 1A is a schematic diagram illustrating a first external shell 110A and a second external shell 120A of an electronic device 10 are assembled according to an embodiment of the present disclosure. FIG. 1B is a schematic diagram illustrating the first external shell 110A and the second external shell 120A of FIG. 1A are disassembled.

The electronic device 10 able to be identified unauthorized disassembly includes a case 100A and a first RFID tamper-evident label 200A. The case 100A includes a first external shell 110A and a second external shell 120A separably assembled with the first external shell 110A. When the first external shell 110A and the second external shell 120A are assembled together, an inner space 140A is defined by the first external shell 110A and the second external shell 120A, and is between the first external shell 110A and the second external shell 120A. The first RFID tamper-evident label 200A is totally disposed in the inner space 140A, and is fixedly connected to both of the first external shell 110A and the second external shell 120A.

Specifically, in one embodiment, the first RFID tamper-evident label 200A is hidden and concealed in the case 100A, and one end of the first RFID tamper-evident label 200A is fixed on an inner surface 111A of the first external shell 110A by adhesive 400A, and the other end of the first RFID tamper-evident label 200A is fixed on an inner surface 121A of the second external shell 120A by adhesive 400B.

It should be understood that any structural element (e.g., boss, lug, rib or holder), integrally or indirectly connected to the first external shell 110A, can be seen as a part of the first external shell 110A, and similarly, any structural element (e.g., boss, lug, rib or holder), integrally or indirectly connected to the second external shell 120A, can be seen as a part of the second external shell 120A. However, no matter the structures of the first external shell 110A and the second external shell 120A are the same or different, the aforementioned adhesives 400A, 400B for separately fixing the first RFID tamper-evident label 200A on the first external shell 110A and the second external shell 120A can be same or different in types.

Furthermore, Information about the electronic device 10 (e.g., serial No., product ID, manufacturing date or/and manufacturing location etc.) is pre-written and stored in the first RFID tamper-evident label 200A while the electronic device 10 is finished, thus, the information in the first RFID tamper-evident label 200A can be read by a RFID reader (not shown in FIGS. 1A and 1B) which is distinct from the electronic device 10 for product identification or use.

As shown in FIG. 1B, since the first RFID tamper-evident label 200A is hidden in the case 100A, once the first external shell 110A and the second external shell 120A are separated, the first RFID tamper-evident label 200A must be torn and broken apart along with a separation of the first external shell 110A and the second external shell 120A. Thus, the information in the first RFID tamper-evident label 200A cannot be read by the RFID reader.

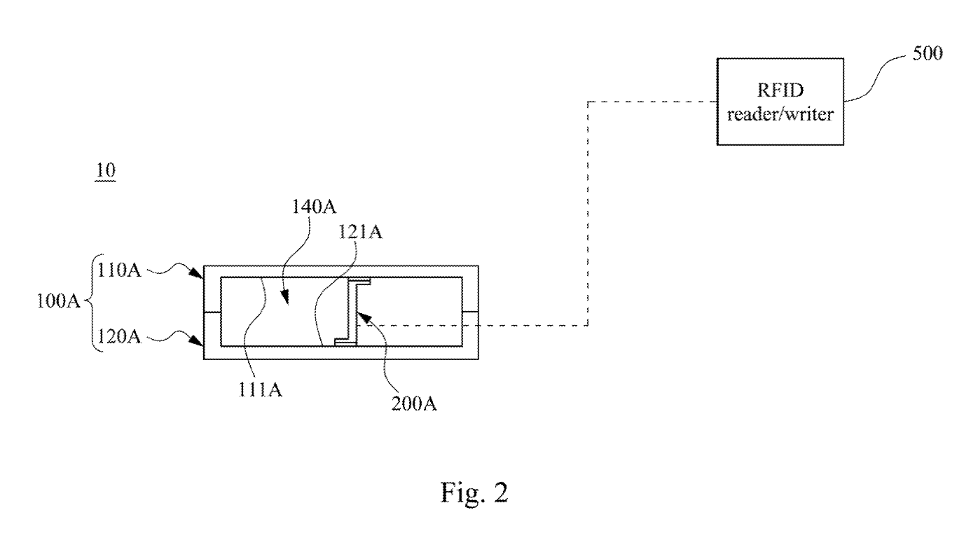

FIG. 2 is a schematic diagram illustrating exemplary manipulations between the electronic device 10 of FIG. 1A and a RFID reader/writer 500.

As a RFID reader/writer 500 attempts to read the information stored in the first RFID tamper-evident label 200A wirelessly, when the information in the first RFID tamper-evident label 200A can be read or obtained by the RFID reader/writer 500, it indicates that the electronic device 10 had never been disassembled after manufacture because the first. RFID tamper-evident label 200A is not broken and still works in the electronic device 10. Oppositely, when the information in the first RFID tamper-evident label 200A cannot be read or obtained by the RFID reader/writer 500, it indicates that the electronic device 10 had been disassembled before, because the first RFID tamper-evident label 200A is broken apart in the electronic device 10 (FIG. 1B).

It is noted, once the first external shell 110A and the second external shell 120A are disassembled to break the first RFID tamper-evident label 200A (FIG. 1B), no matter the first external shell 110A and the second external shell 120A are reassembled again, the first RFID tamper-evident label 200A is still broken, and the information in the first RFID tamper-evident label 200A cannot be read by the RFID reader/writer 500 anymore.

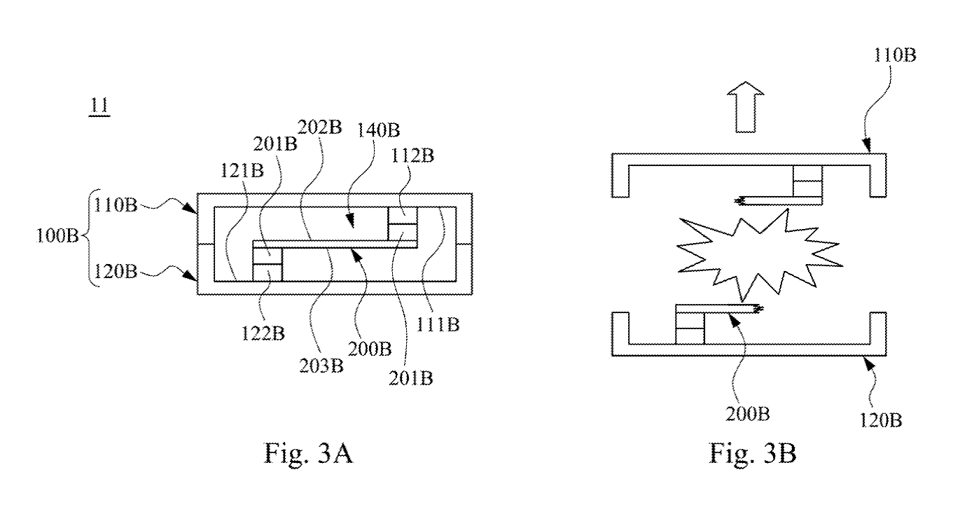

Reference is now made to FIG. 3A and FIG. 3B in which FIG. 3A is a schematic diagram illustrating a first external shell 110B and a second external shell 120B of an electronic device 11 are assembled according to an embodiment of the present disclosure, and FIG. 3B is a schematic diagram illustrating the first external shell 110B and the second external shell 120B of FIG. 3A are disassembled.

Refer to FIG. 3A of the embodiment, the first RFI tamper-evident label 200B can be fixed to both the first external shell 110B and the second external shell 120B by detachably coupling means rather than adhesive.

Substantially, two first coupling elements 201B are respectively formed on two different or opposite surfaces 202B, 203B of the first RFI tamper-evident label 200B. A second coupling element 112B is formed on an inner surface 111B of the first external shell 110B, and can be fixed with the first coupling element 201B. A third coupling element 122B is formed on an inner surface 121B of the second external shell 120B, and can be fixed with the other first coupling element 201B.

However, no matter the structures of the first external shell 110B and the second external shell 120B are the same or different, the two first coupling elements 201B for separately fixing with the second coupling element 112B and the third coupling element 122B can be same or different in types.

Thus, when the first external shell 110B and the second external shell 120B are assembled together, one of the first coupling elements 201B is fixed with the second coupling element 112B, and the other first coupling element 201B is fixed with the third coupling element 122B.

One of the first coupling elements 201B and the second coupling element 112B are matched with each other, can be for example, including, but not limited to, hooks, magnets or screwing-attached structures. The other first coupling element 201B and the third coupling element 122B are matched with each other, can be for example, including, but not limited to, hooks, magnets or screwing-attached structures.

Since the structures of the first coupling elements the second coupling element and the third coupling element are not limited in types, as long as the first coupling element and the second coupling element (or the third coupling element) are fixedly connected with each other, the connection types of the first coupling element and the second coupling element (or the third coupling element) are not limited in the invention, that is, the first coupling element can be engaged with, fixed, linked, attached, bonded, hooked or coupled to the second coupling element (or the third coupling element).

As shown in FIG. 3B, once the first external shell 110B and the second external shell 120B are separated, the first RFID tamper-evident label 200B must be torn and broken apart by the first external shell 110B and the second external shell 120B. Thus, the information in the first RFID tamper-evident label 200B cannot be read by the RFID reader.

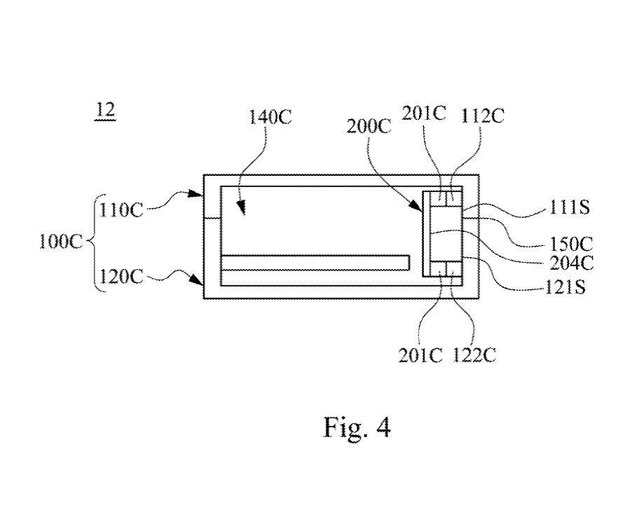

FIG. 4 is a schematic diagram illustrating a first external shell 110C and a second external shell 120C of an electronic device 12 are assembled according to an embodiment of the present disclosure.

As shown in FIG. 4, according to one alternative of this embodiment, the first coupling elements 201C are both disposed on the same surface 204C of the first RFID tamper-evident label 200C. The second coupling element 112C is disposed on a lateral inner surface 111S of the first external shell 110C, and the third coupling element 122C is disposed on a lateral inner surface 121S of the second external shell 120C. The first RFID tamper-evident label 200C covers a seam 150C defined by the lateral inner surface 111S and the lateral inner surface 121S with the surface 204C of the first RFID tamper-evident label 200C. Thus, it can decrease an occupied space of the first RFID tamper-evident label 200C in the inner space 140C.

However, no matter the structures of the first external shell 110C and the second external shell 120C are the same or different, the two first coupling elements 201C for separately engaging with the second coupling element 112C and the third coupling element 122C can be same or different in types.

Since the structures of the first coupling elements, the second coupling element and the third coupling element are not limited in types, as long as the first coupling element and the second coupling element (or the third coupling element) are fixedly connected with each other, the connection types of the first coupling element and the second coupling element (or the third coupling element) are not limited in the invention, that is, the first coupling element can be engaged with, fixed, linked, attached, bonded, hooked or coupled to the second coupling element (or the third coupling element).

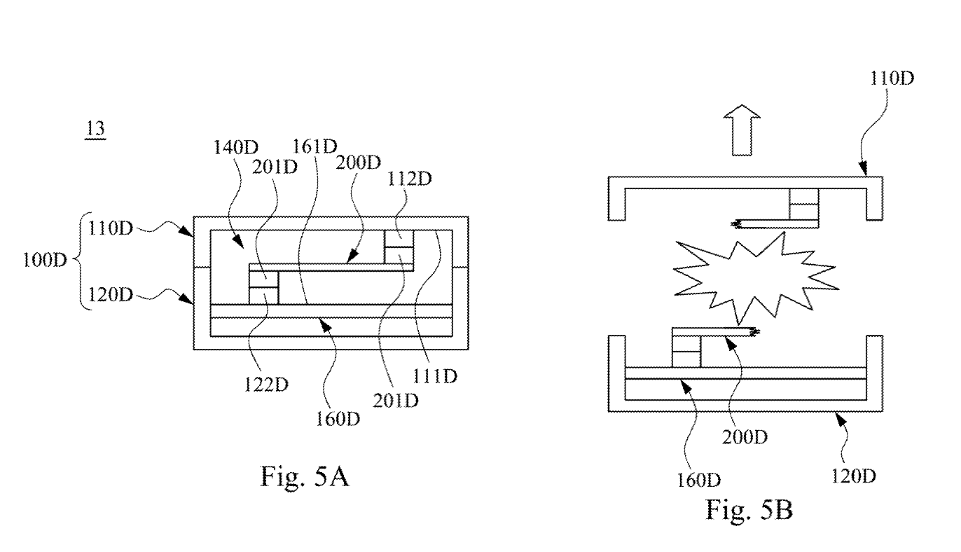

Reference is also made to FIG. 5A and FIG. 5B in which FIG. 5A is a schematic diagram illustrating a first external shell 110D and a second external shell 120D of an electronic device 13 are assembled according to an embodiment of the present disclosure, and FIG. 5B is a schematic diagram illustrating the first external shell 110D and the second external shell 120D of FIG. 5A are disassembled.

The electronic device 13 further includes an electronic module 160D disposed in the inner space 140D of the electronic device 13. The first RFID tamper-evident label 200D is totally disposed in the inner space 140D, and is connected to both of the first external shell 110D and the electronic module 160D. Specifically, in one embodiment, the electronic module 160D is fixed to the second external shell 120D. One end of the first RFID tamper-evident label 200D is fixed on an inner surface 111D of the first external shell 110D by adhesive (not shown in the figure) or the aforementioned detachably coupling means 201D, 112D, and the other end of the first RFD tamper-evident label 200D is fixed on a surface 161D of the electronic module 160D by adhesive (not shown in the figure) or the aforementioned detachably coupling means 201D, 122D. However, the two first coupling elements 201D for separately fixing the second coupling element 112D and the third coupling element 122D can be same or different in types.

Since the structures of the first coupling elements, the second coupling element and the third coupling element are not limited in types, as long as the first coupling element and the second coupling element (or the third coupling element) are fixedly connected with each other, the connection types of the first coupling element and the second coupling element (or the third coupling element) are not limited in the invention, that is, the first coupling element can be engaged with, fixed, linked, attached, bonded, hooked or coupled to the second coupling element (or the third coupling element).

The electronic module 160D is a generic term including components contained in the inner space 140D. For examples, the electronic module 160D can include one or more of a circuit board (e.g., printed circuit board, PCB or Flexible Print Circuit, FPC), an electronic component (e.g., processor chip, SMD element or connection port or HDD), a shielding component (e.g., metal box, frame or post) and a grounding component (e.g., metal box, frame or post).

As shown in FIG. 5B, since the electronic module 160D is fixed to the second external shell 120D, once the first external shell 110D and the second external shell 120D are separated, the first RFID tamper-evident label 200D must be torn and broken apart by the first external shell 110D and the electronic module 160D. Thus, the information in the first RFID tamper-evident label 200D cannot be read by the RFID reader.

However, how the first external shell 110D and the second external shell 120D separated is not limited in the disclosure, for example, if the first external shell 110D is pivotally connected to the second external shell 120D, the first external shell 110D can be rotated to separate from the second external shell 120D.

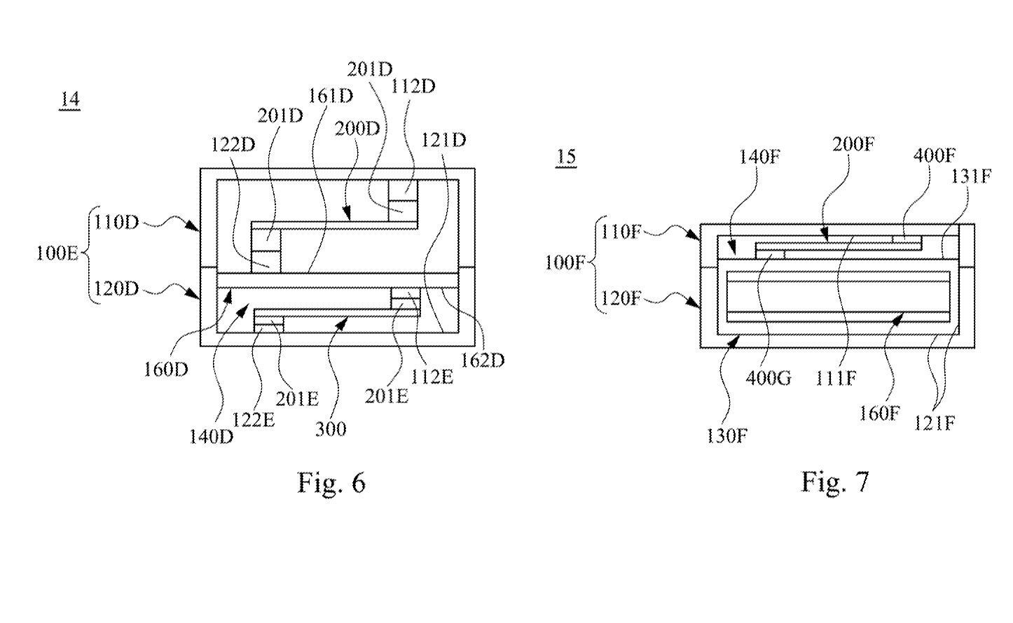

Reference is now made to FIG. 6, which is a schematic diagram illustrating a first external shell 110D and a second external shell 120D of an electronic device 14 are assembled according to an embodiment of the present disclosure.

Based on aforesaid embodiment, comparing to the electronic device 13 in FIG. 5A, besides the first RFID tamper-evident label 200D is connected to both of the first external shell 110D and the electronic module 160D, the electronic device 14 in FIG. 6 further comprises a second RFID tamper-evident label 300. The second RFID tamper-evident label 300 is totally disposed in the inner space 140D, and is connected to an inner surface 121D of the second external shell 120D and the electronic module 160D.

Similarly, the second RFID tamper-evident label 300 is hidden and concealed in the case 100E, and one end of the second RFID tamper-evident label 300 is fixed on a surface 162D of the electronic module 160D by adhesive (not shown in the figure) or the aforementioned detachably coupling means 201E, 112E, and the other end of the second RFID tamper-evident label 300 is fixed on an inner surface 121D of the second external shell 120D by adhesive (not shown in the figure) or the aforementioned detachably coupling means 201E, 122E.

However, no matter the structures of the first external shell 110D and the second external shell 120D are the same or different, the two first coupling elements 201E for separately fixing with the second coupling element 112E and the third coupling element 122E can be same or different in types.

Since the structures of the first coupling elements, the second coupling element and the third coupling element are not limited in types, as long as the first coupling element and the second coupling element (or the third coupling element) are fixedly connected with each other, the connection types of the first coupling element and the second coupling element (or the third coupling element) are not limited in the invention, that is, the first coupling element can be engaged with, fixed, linked, attached, bonded, hooked or coupled to the second coupling element (or the third coupling element).

Also, information same as that in the first RFID tamper-evident label 200D can be pre-written and stored in the second RFID tamper-evident label 300, thus, the information in the second RFID tamper-evident label 300 can be read by the RFID reader as well.

However, besides the serial No., the product ID, the manufacturing date or/and the manufacturing location of the electronic device 14 described above, the information in the second RFID tamper-evident label 300 still includes an identification code distinguished from another in the first RFID tamper-evident label 200D. Thus, when the RFID reader/writer 500 (FIG. 2) only reads one identification code representing to the first RFID tamper-evident label 200D or the second RFID tamper-evident label 300, people can be informed that not only the electronic device 14 had been disassembled before, but also further obtain a message that the first external shell 110D or the second external shell 120D is detached away only.

Reference is now made to FIG. 7, which is a schematic diagram illustrating a first external shell 110F and a second external shell 120F of an electronic device 15 are assembled according to an embodiment of the present disclosure.

As shown in FIG. 7, according to one embodiment, the electronic device 15 further comprises an anti-collision body 130F. The anti-collision body 130F is disposed in the inner space 140F, surrounds and wraps the electronic module 160F as a cushion of the electronic module 160F for protecting the electronic module 160F. The anti-collision body 130F is attached with the inner surfaces 121F of the second external shell 120F, so that the anti-collision body 130F can be seen as a part of the second external shell 120F as well. For example, the electronic module 160F can be a solid-state driver (SSD) or a hard disk driver (HDD).

The first RFID tamper-evident label 200F is fixed on both the anti-collision body 130F and the first external shell 110F. Particularly, one end of the first RFID tamper-evident label 200F is fixed on an outer surface 131 of the anti-collision body 130F with adhesive 400F or the aforementioned detachably coupling means (not shown in the figure), the other end of the first RFID tamper-evident label 200F is fixed on the inner surface 111F of the first external shell 110F with adhesive 400G or the aforementioned detachably coupling means (not shown in the figure).

However, no matter the structures of the first external shell 110F and the second external shell 120F are the same or different, the aforementioned adhesives 400F, 400G for separately fixing the first RFID tamper-evident label 200F on the first external shell 110F and the second external shell 120F can be a or different in types.

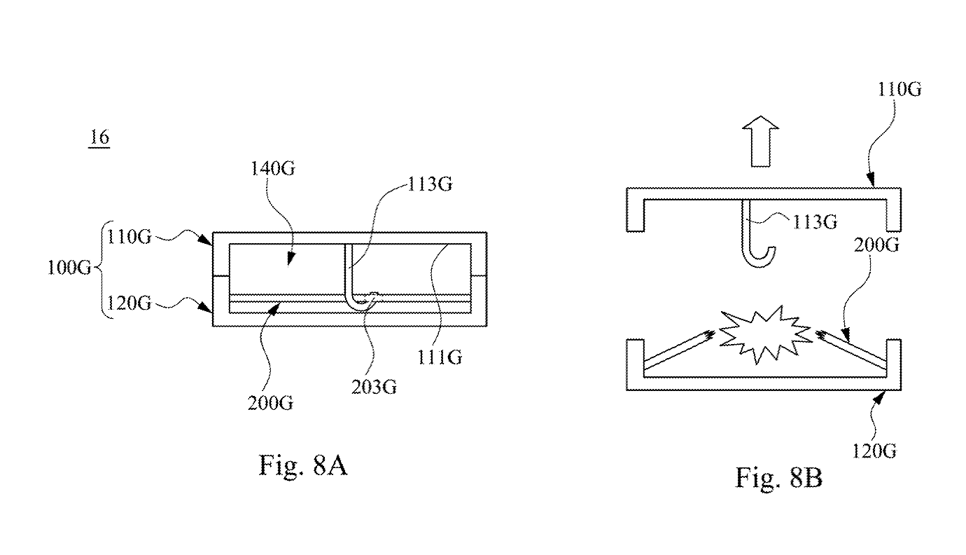

Reference is now made to FIG. 8A and FIG. 8B, in which FIG. 8A is a schematic diagram illustrating a first external shell 110G and a second external shell 120G of an electronic device 16 are assembled according to an embodiment of the present disclosure, and FIG. 8B is a schematic diagram illustrating the first external shell 110G and the second external shell 120G of FIG. 8A are disassembled.

As shown in FIG. 8A, in this embodiment, two ends of the first RFID tamper-evident label 200G connect to the second external shell 120G. The first external shell 110G comprises a clasp 113 extended from the inner surface 111G of the first external shell 110G to hook a part of the first RFID tamper-evident label 200G between two ends of the first RFID tamper-evident label 200G.

As long as the two ends of the first RFID tamper-evident label 200G are can be fixedly connected to the second external shell 120G, the connection types that the two ends of the first RFID tamper-evident label 200G being respectively connected to the second external shell 120G are not limited in the invention, that is, the two ends of the first RFID tamper-evident label 200G can be engaged with, fixed, linked, attached, bonded, hooked or coupled to the second external shell 120G.

As shown in FIG. 8B, when the first external shell 110G and the second external shell 120G are separated, the first RFID tamper-evident label 200G can be torn and broken apart by the clasp 113.

In particular, the clasp 113 hooks to a hole 203 of the first RFID tamper-evident label 200G, so that the first RFID tamper-evident label 200G is easy to be broken by the clasp 113 when the first external shell 110G and the second external shell 120G are separated. Thus, the information in the first RFID tamper-evident label 200G cannot be read by the RFID reader.

However, the disclosure is not only limited to this, the clasp also can hook to a narrow part or the whole body (not shown in the figure) of the first RFID tamper-evident label as well. Also, besides the first RFID tamper-evident label 200 connects to the second external shell 120 with both ends thereof, in other alternatives, both ends of the first RFID tamper-evident label 200 also can be connected to any two of the first external shell, the second external shell and the electronic module.

It is noted that after the first external shell and the second external shell are closed, one of possible ways to install the RFID tamper-evident label(s) in the case, but not limited to, is to fix the RFID tamper-evident label(s) in the case through an opening of the case before the opening is sealed.

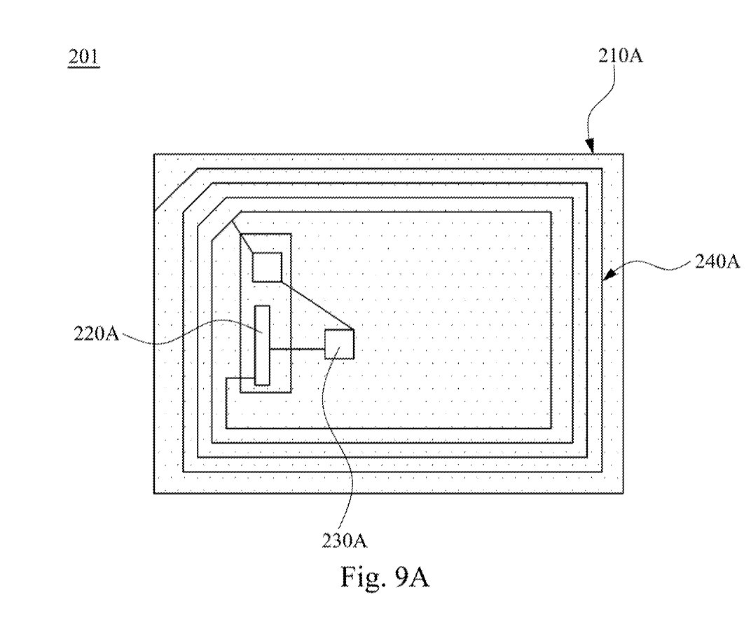

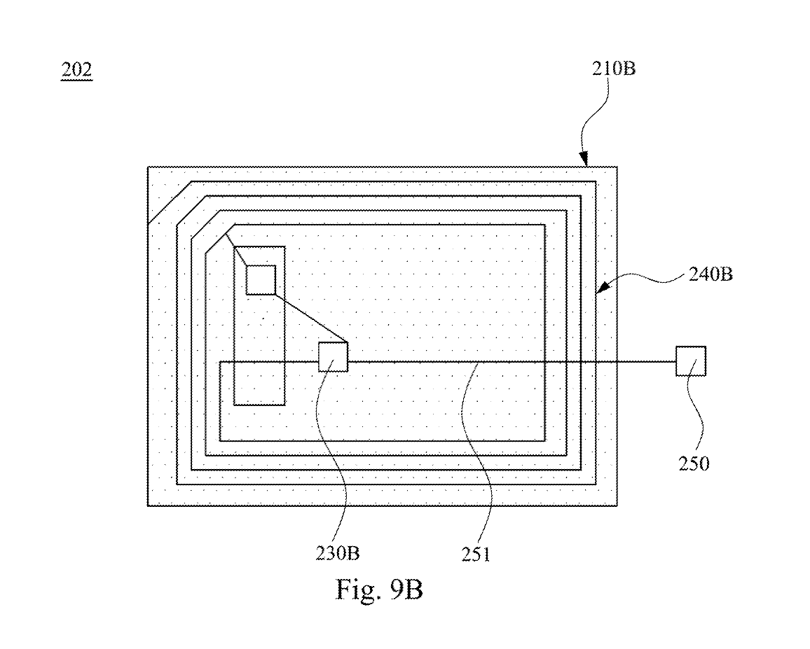

Reference is now made to FIG. 9A which is a front view illustrating the first RFID tamper-evident label 201 according to an embodiment of the present disclosure.

According to the embodiment, the first RFID tamper-evident label 201 comprises a substrate 210A, a capacitor 220A, a RFID chip 230A (also called application specific integrated circuit, ASIC) and an antenna circuit 240A (also called inductor coil). The substrate 210A can be torn into two pieces easily, and the substrate 210A is made of a variety of suitable materials, for example, including, but not limited to, organic material (e.g., paper, polyester or resin). The antenna circuit 240A, the capacitor 220A and the RFID chip 230A are arranged on the substrate 210A, and electrically connected to each other. The antenna circuit 240A communicates with the RFID reader/writer 500 (FIG. 2), and passes a read-information-request to the RFID chip 230A, and passes the information to the RFID reader/writer 500 (FIG. 2). The RFID chip 230A outputs the information in the first RFID tamper-evident label 201A to the RFID reader/writer 500 (FIG. 2) via the antenna circuit 240A. The capacitor 220A saves power and provides the power to the antenna circuit 240A and the RFID chip 230A. In the embodiment, the RFID chip 230A comprises a modulation circuitry, a control circuitry, a memory and a processor (not shown in the figure). Thus, when the first RFID tamper-evident label 201A is broken, the antenna circuit 240A is damaged and malfunctioned.

Reference is now made to FIG. 9B which is a front view illustrating the first RFID tamper-evident label 202 according to an embodiment of the present disclosure.

The first RFID tamper-evident label 202 in this embodiment comprises a substrate 210B, a power source 250 (e.g., battery), a RFID chip 230B (also called application specific integrated circuit, ASIC) and an antenna circuit 240B (also called inductor coil). The substrate 210B can be torn into pieces easily, and the substrate 210B is made of a variety of suitable materials, for example, including, but not limited to, paper material, polyester material or resin material. The antenna circuit 240B and the RFID chip 230B are arranged on the substrate 210B, and electrically connected to each other. The antenna circuit 240B communicates with the RFID reader/writer 500, and passes a read-information-request to the RFID chip 230B, and passes the information to the RFID reader/writer 500. The RFID chip 230B outputs the information in the first RFID tamper-evident label 202 to the RFID reader/writer 500 via the antenna circuit 240B. The power source 250 as an active power source, connects to the RFID chip 230B and the antenna circuit 240B, and provides power to the antenna circuit 240B and the RFID chip 230B. Thus, when the first RFID tamper-evident label 202B is broken, a connection line 251 between the RFID chip 230B and the power source 250 is cut, i.e., the RFID chip 230B is electrically disconnected to the power source 250.

The first RFID tamper-evident label 202 mentioned above might be either active or passive, the active type including a battery for powering the transceiver whereas the passive type derives operating power from the RF signal used to interrogate the tag.

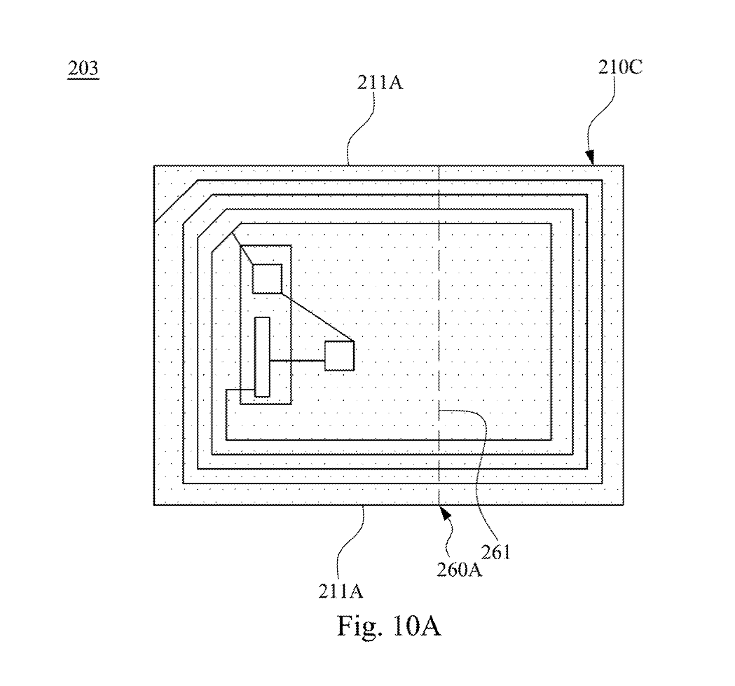

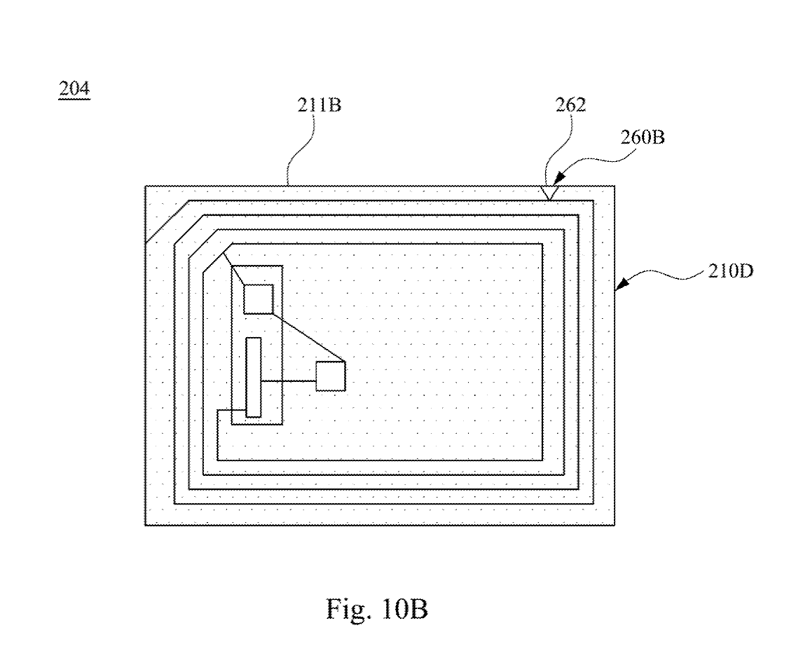

Reference is now made to FIGS. 10A and 10B in which FIG. 10A is a front view illustrating the first RFID tamper-evident label 203 with a tear structure 260A according to an embodiment of the present disclosure and FIG. 10B is a front view illustrating the first RFID tamper-evident label 204 with another tear structure 260B according to an embodiment of the present disclosure.

As shown in FIG. 10A, the first RFID tamper-evident label 203 also comprises a tear structure 260A. The tear structure 260A is formed on the substrate 210C of the first RFID tamper-evident label 203 for smoothly tearing the first RFID tamper-evident label 203.

In one variation of the embodiment of the disclosure, as shown in FIG. 10A, the tear structure 260B can be a dotted line 261 arranged across the substrate 210c between two opposite edges 211A of the substrate 210C of the first RFID tamper-evident label 203. Thus, when the first external shell 110A and the second external shell 120A are separated (FIG. 1B), by tearing along the dotted line 261, the first RFID tamper-evident label 203 can be easily torn apart.

In another variation of the embodiment of the disclosure, as shown in FIG. 10B, the tear structure 260B can be a V-shaped break 262 formed on an edge 211B of the substrate 210D of the first RFID tamper-evident label 204. Thus, when the first external shell 110A and the second external shell 120A are separated (FIG. 1B), by tearing from the V-shaped break 262, the first RFID tamper-evident label 204 can be easily torn apart.

However, in those embodiments above, how the first external shell and the second external shell separated is not limited in the disclosure. For example, if the first external shell and the second external shell can be totally separated, the first external shell and the second external shell can be separated in two opposite directions, or the first external shell can be separated in related to the second external shell, otherwise, if the first external shell is pivotally connected to the second external shell, the first external shell can be rotated to be far away from the second external shell.

Based on aforesaid embodiments, this disclosure provides an electronic device for being identified whether the electronic device had been disassembled under no authorization, since the RFID tamper-evident label is hidden inside the electronic device, the identification result whether the electronic device had been unauthorizedly disassembled can be automatically aware of, and the aesthetic of the electronic device is enhanced.

Although the present disclosure has been described with reference to the preferred embodiments thereof, it is apparent to those skilled in the art that a variety of modifications and changes may be made without departing from the scope of the present disclosure which is intended to be defined by the appended claims.

The reader/writer's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. An electronic device able to be identified unauthorized disassembly, comprising:
a case comprising:
a first external shell; and
a second external shell separably assembled with the first external shell, wherein an inner space is defined between the first external shell and the second external shell;
an electronic module disposed in the inner space; and
a first RFID tamper-evident label disposed in the inner space, connected to any two of the first external shell, the second external shell and the electronic module,
wherein the first RFID tamper-evident label is configured to be broken apart along with a separation of the first external shell and the second external shell.

2. The electronic device able to be identified unauthorized disassembly according to claim 1, wherein two first coupling elements are oppositely formed on the first RFID tamper-evident label, and
a second coupling element and a third coupling element are respectively formed on the two of the first external shell, the second external shell and the electronic module,
wherein one of the two first coupling elements and the second coupling element are fixed together, and the other of the two first coupling elements and the third coupling element are fixed together.

3. The electronic device able to be identified unauthorized disassembly according to claim 2, wherein one of the first coupling elements and the second coupling element are hooks, magnets or screwing-attached structures, and
the other of the first coupling elements and the third coupling element are hooks, magnets or screwing-attached structures.

4. The electronic device able to be identified unauthorized disassembly according to claim 2, wherein the two first coupling elements are both disposed on a surface of the first RFID tamper-evident label.

5. The electronic device able to be identified unauthorized disassembly according to claim 2, wherein the two first coupling elements are separately disposed on two different surfaces of the first RFID tamper-evident label.

6. The electronic device able to be identified unauthorized disassembly according to claim 1, wherein two ends of the first RFID tamper-evident label respectively are fixed on an inner surface of the first external shell and an inner surface of the second external shell by adhesive.

7. The electronic device able to be identified unauthorized disassembly according to claim 1, wherein the second external shell comprises an anti-collision body disposed in an inner space, and surrounding the electronic module,
wherein one of the ends of the first RFID tamper-evident label is fixed on a surface of the anti-collision body, and the other of the ends of the first RFID tamper-evident label is fixed on one of the first external shell and the electronic module.

8. The electronic device able to be identified unauthorized disassembly according to claim 1, wherein two ends of the first RFID tamper-evident label respectively are fixed on an inner surface of the first external shell and the electronic module, wherein the electronic module is fixed to the second external shell.

9. The electronic device able to be identified unauthorized disassembly according to claim 8, further comprising:
a second RFID tamper-evident label totally disposed in the inner space, and connected to an inner surface of the second external shell and the electronic module.

10. The electronic device able to be identified unauthorized disassembly according to claim 1, wherein the electronic module comprises one selected from a group consisting of a circuit board, an electronic component, a shielding component and a grounding component.

11. The electronic device able to be identified unauthorized disassembly according to claim 1, wherein the first RFID tamper-evident label comprises:
a tear structure arranged on the first RFID tamper-evident label for smoothly tearing the first RFID tamper-evident label apart.

12. The electronic device able to be identified unauthorized disassembly according to claim 1, wherein information in the first RFID tamper-evident label is configured to be unreadable once the first RFID tamper-evident label is broken apart.

13. The electronic device able to be identified unauthorized disassembly according to claim 12, wherein the first RFID tamper-evident label comprises:
a substrate;
a RFID chip arranged on the substrate; and
an antenna circuit arranged on the substrate, electronically connected to the RFID chip, being configured to output the information in the first RFID tamper-evident label for being read,
wherein, when the first RFID tamper-evident label is broken apart, the antenna circuit is malfunctioned.

14. The electronic device able to be identified unauthorized disassembly according to claim 12, wherein the first RFID tamper-evident label comprises:
a substrate;
a RFID chip arranged on the substrate; and
an antenna circuit arranged on the substrate, electronically connected to the RFID chip, being configured to output the information in the first RFID tamper-evident label for being read,
a power source electronically connected to the RFID chip to provide operation power of the RFID chip,
wherein, when the first RFID tamper-evident label is broken apart, the RFID chip is electronically disconnected to the power source.

15. An electronic device able to be identified unauthorized disassembly comprising:
a case comprising an inner space defined between a first external shell and a second external shell, wherein the first external shell and the second external shell are separably assembled with each other; and
a first RFID tamper-evident label arranged in the inner space,
wherein the first RFID tamper-evident label is configured to be broken along with a separation of the first external shell and the second external shell, and information stored therein is unreadable after the first RFID tamper-evident label is broken.

16. The electronic device able to be identified unauthorized disassembly according to claim 15, further comprising:
an electronic module totally contained in the inner space, and fixed to the first external shell or the second external shell,
wherein the first RFID tamper-evident label is connected to any two of the first external shell, the second external shell and the electronic module.

17. The electronic device able to be identified unauthorized disassembly according to claim 16, wherein two first coupling elements are oppositely formed on the first RFID tamper-evident label, and
a second coupling element and a third coupling element are respectively formed on two of the first external shell, the second external shell and the electronic module,
wherein one of the first coupling elements and the second coupling element are engaged together, the other of the first coupling elements and the third coupling element are engaged together.

18. The electronic device able to be identified unauthorized disassembly according to claim 17, wherein any two of the first coupling elements, the second coupling element and the third coupling element are hooks, magnets or screwing-attached structures.

19. The electronic device able to be identified unauthorized disassembly according to claim 15, further comprising:
an anti-collision body in the inner space, and surrounding an electronic module,
wherein the first RFID tamper-evident label is connected to the second external shell and the anti-collision body.

20. The electronic device able to be identified unauthorized disassembly according to claim 15, wherein the first external shell comprises a clasp formed on an inner surface thereof, and the clasp hooks on a part of the first RFID tamper-evident label between two ends of the first RFID tamper-evident label,
wherein the first RFID tamper-evident label is broken by the clasp when the first external shell and the second external shell are separated.
